(19) United States
(12) Patent Application Publication
(10) Pub. No.: US 2023/0170477 A1
(43) Pub. Date: Jun. 1, 2023

(54) COMPOSITE CATHODE MATERIALS FOR LITHIUM-ION BATTERIES AND METHODS FOR MANUFACTURING THE SAME

(71) Applicant: Rivian IP Holdings, LLC, Irvine, CA (US)

(72) Inventors: Soo Kim, Fremont, CA (US); Johnson Mark, San Jose, CA (US); Tae Kyoung Kim, Sunnyvale, CA (US); Ki Tae Park, Santa Clara, CA (US)

(21) Appl. No.: 17/536,552

(22) Filed: Nov. 29, 2021

(51) Int. Cl. H01M 4/525; H01M 10/0525; H01M 4/58; H01M 4/62

(52) U.S. Cl. CPC H01M 4/525; H01M 10/0525; H01M 4/58; H01M 4/625

(57) ABSTRACT

A blended lithium-ion electrode for an electric vehicle and methods of manufacturing the electrode are disclosed. The blended lithium-ion electrode includes a first mixture of a lithium metal oxide comprised of LiXO₂, wherein X is selected from the group consisting of nickel, cobalt, manganese, aluminum, iron, or mixtures thereof; and a second mixture of a lithium iron phosphate comprised of LiYPO₄, wherein Y is selected from the group consisting of iron, manganese, cobalt, nickel, aluminum, titanate, or mixtures thereof. In further embodiments, the blended lithium-ion electrode includes graphene sheets to provide structure, electrochemical stabilizer, and electronic conductivity enhancer.

### INTRODUCTION

Electric vehicles require a source of electricity to operate. Typically, electric vehicles use large battery packs, which consist of a plurality of batteries. The chemistry of the materials in the batteries varies and is in need of improvement.

Electric vehicles rely almost exclusively on rechargeable lithium-ion batteries as the source of power. The cathode of the lithium-ion batteries is one variable that can alter the battery's performance. The chemistry of the cathode in the lithium-ion batteries is a factor in determining energy density and the cycle life. One type of cathode material for the lithium-ion batteries is lithium metal oxides in LiXO₂ (X=Nickel Ni, Manganese Mn, Cobalt Co), typically Ni-rich LiXO₂, with 60-95 mol % Ni. Another type of cathode material for the lithium-ion batteries is a lithium iron phosphate cathode material in LiFePO₄ (LFP). A common approach to improving thermal stability has been to use lithium iron phosphate cathode material with lower energy density than Ni-rich lithium metal oxide cathodes. Although the energy density of lithium iron phosphate is lower than high Ni-containing lithium metal oxide cathodes, the lithium iron phosphate has a lower raw materials cost and better thermal stability than a lithium metal oxide. Similarly, Nickel-rich based LiXO₂ cathode materials release heat flow of about 200-250° C. by undergoing thermal decomposition, while lithium iron phosphate is quite stable at this temperature range and beyond (e.g., above 350° C., while other components other than cathode may be affected).

Therefore, it would be beneficial to identify the chemistry of a cathode for lithium-ion batteries capable of improving energy density, maintaining thermal stability, and providing protection from multiple charge and discharge cycles compared to the well-known lithium metal oxide cathodes or lithium iron phosphate cathodes.

### SUMMARY OF THE DISCLOSURE

This disclosure provides a novel blended lithium-ion electrode useful for lithium-ion batteries in an electric vehicle, wherein the blended lithium-ion electrode has an improved ability to prevent overheating. At the same time, maintain the energy density of the blended lithium-ion electrode in the lithium-ion battery, as compared to the well-known lithium metal oxide cathodes or lithium iron phosphate cathodes.

In some embodiments of the disclosure include different electrode design configurations and methods of preparing blended electrodes between lithium iron phosphate (LFP) and lithium metal oxide (e.g., NMC materials). In some embodiments, the blended lithium-ion electrode includes a first mixture of a lithium metal oxide comprised of LiXO₂, wherein X is selected from the group comprising of nickel, cobalt, manganese, aluminum, iron, or mixtures thereof and a second mixture of a lithium iron phosphate comprised of LiYPO₄, wherein Y is selected from the group comprising of iron, manganese, cobalt, nickel, aluminum, titanate, or mixtures thereof. The first mixture and the second mixture are mixed into a blended mixture with a ratio of the first mixture to the second mixture from 0.01 to 99.99. In some embodiments, the blended lithium-ion electrode is a cathode of a lithium-ion battery. In some embodiments, the blended lithium-ion electrode includes a first mixture of a lithium metal oxide comprised of LiXO₂, wherein X comprises one or more of nickel, cobalt, manganese, aluminum, iron, or mixture thereof and a second mixture of a lithium iron phosphate comprised of LiYPO₄, wherein Y comprises one or more of iron, manganese, cobalt, nickel, aluminum, titanate, or mixture thereof.

In some embodiments, the blended lithium-ion electrode includes a carbon-based material such as two-dimensional (2D) graphene materials. For example, a graphene additive is mixed into the blended electrode of the first mixture and the second mixture. The graphene additive may be in the form of a graphene sheet, that is whole or in smaller sizes or including holes configured for ions to pass through. The concentration of the graphene in the blended lithium-ion electrode of the first mixture and the second mixture is at 0.01 to 30 wt %. In some embodiments, the concentration of the graphene in the blended lithium ion mixture is 0.02-25 wt %, 0.03-20 wt %, 0.04-15 wt %, 0.05-10 wt %, 0.05-5 wt %, 0.05-2.5 wt %, 0.05-2.5 wt %, etc. The graphene additive is configured to provide structure, electrochemical stabilizer and electronic conductivity enhancer to the blended electrode. In some embodiments, the addition of graphene sheets may cause the formation of a very stable solid electrolyte interface (SEI) on the cathode side. The addition of graphene sheets may be configured to help stabilize the interface between electrode and electrolyte in the event of electrolyte decomposition at high voltage operation. In some embodiments, the blended electrode may include nano-sized lithium iron phosphate and graphene that cause the electrolyte wetting process that ensures uniform Li⁺ ion (de-)insertion. In some embodiments, the blended electrode may increase energy density, charging capability, and thermal stability.

In some embodiments, a blended lithium-ion electrode comprises a first mixture of a lithium metal oxide comprised of LiXO₂, wherein X is selected from the group consisting of nickel, cobalt, manganese, aluminum, iron, or mixtures thereof; and a second mixture of a lithium iron phosphate comprised of LiYPO₄, wherein Y is selected from the group consisting of iron, manganese, cobalt, nickel, aluminum, titanate, or mixtures thereof. In some embodiments, the first mixture and the second mixture are blended into a blended mixture with a ratio of the first mixture to the second mixture from 0.01 to 99.99. In some embodiments, the blended electrode is a cathode. In some embodiments, the X in the first mixture of the blended electrode is nickel (e.g., NMC811, NCA, Ni90, etc.).

In some embodiments, the blended lithium-ion electrode further comprises a graphene additive mixed into the blended electrode of the first mixture and the second mixture, wherein a concentration of the graphene additive is configured to provide structure and electrochemical stabilizer and electronic conductivity enhancer.

In some embodiments, the blended lithium-ion electrode is part of an electrochemical cell. In some embodiments, the first mixture of the lithium metal oxide has a higher energy density than the second first mixture of the lithium iron phosphate. In some embodiments, the second first mixture of the lithium iron phosphate has higher thermal properties than the first mixture of the lithium metal oxide. In some embodiments, the electrochemical cell includes a ratio between the first mixture of the lithium metal oxide comprised of LiXO₂ and the second mixture of the lithium iron phosphate comprised of LiYPO₄ selected to balance the energy density and thermal properties between the two mixtures.

In some embodiments, a concentration of the first mixture in the blended electrode is in a range of 1-10 weight % (wt. %). In some embodiments, a concentration of the first mixture in the blended electrode is in a range of 1.5-5 wt. %. In some embodiments, a concentration of the first mixture in the blended electrode is in a range of 2.5-4 wt. %. In some embodiments, the first mixture of the lithium metal oxide is comprised of LiXZO₄, wherein Z is selected from the group consisting of nickel, cobalt, manganese, aluminum, iron, or mixtures thereof conversion-type. In some embodiment, to increase the energy (e.g., cell capacity) in the lithium-ion battery, the blended lithium-ion electrode includes an increased amount of lithium metal oxide (e.g., NMC). In some embodiment, to increase the thermal stability (e.g., reduce thermal degradation) in the lithium-ion battery, the blended lithium-ion electrode includes an increased amount of lithium iron phosphate (e.g., LFP).

In some embodiments, the blended lithium-ion electrode comprises a protective coating. The protective coating is configured to be resistant against electrolyte degradation that can scavenge HF and PF₅⁻. In some embodiments, the protective coating comprises LiF that is configured to facilitate cell cycling. In some embodiments, the protective coating comprises LiOH configured against electrolyte decomposition.

In some embodiments, the blended lithium-ion electrode is part of an electrochemical cell. The electrochemical cell may be configured with a cell capacity in a range of 1 to 300 Ah. In some embodiment, the electrochemical cell may be configured with a cell capacity in a range of 80 to 180 Ah. In some embodiments, the electrochemical cell may be configured with an average voltage range from 3.2 to 4.4 V vs. graphite. In some embodiments, the electrochemical cell may be configured with an average capacity in a range from 120 to 250 mAh/g when charged at a 0.1 C-rate (10 hours charging or discharging). In some embodiments, the blended electrode is part of a lithium-ion battery. In some embodiments, the lithium-ion battery is configured for use in an electric vehicle. In some embodiments, the first mixture and the second mixture enable charging the battery at a 2 C-rate (30 minutes charging or discharging). In some embodiments, the first mixture and the second mixture enable charging the battery at a 3 C-rate (20 minutes charging or discharging). In some embodiments, the first mixture and the second mixture enable charging the battery at greater than a 3C-rate (shorter than 20 minutes charging or discharging).

In some embodiment, a lithium-ion battery comprises an anode; a blended electrode disposed opposite the anode, wherein the blended electrode comprises: a first mixture of a lithium metal oxide comprised of LiXO₂, wherein X is selected from the group consisting of nickel, cobalt, manganese, aluminum, iron, or mixtures thereof; and a second mixture of a lithium iron phosphate comprised of LiYPO₄, wherein Y is selected from the group consisting of iron, manganese, cobalt, nickel, aluminum, titanate, or mixtures thereof, wherein the first mixture and the second mixture are blended into a blended mixture with a ratio of the first mixture to the second mixture from 0.01 to 99.99, a separator configured between the anode and the blended electrode, and an electrolyte disposed between the anode and the blended electrode.

In yet another embodiment, a method of manufacturing a blended lithium-ion electrode is described. The method of manufacturing the blended lithium-ion electrode comprises providing a first mixture of a lithium metal oxide comprised of LiXO₂, wherein X is selected from the group consisting of nickel, cobalt, manganese, aluminum, iron, or mixtures thereof; providing a second mixture of a lithium iron phosphate comprised of LiYPO₄, wherein Y is selected from the group consisting of iron, manganese, cobalt, nickel, aluminum, titanate, or mixtures thereof; and combining the first mixture and the second mixture into a blended mixture with a ratio of the first mixture to the second mixture from 0.01 to 99.99.

### BRIEF DESCRIPTION OF THE FIGURES

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows a schematic diagram of the cell configuration of a lithium metal oxide cathode on the left and a lithium metal phosphate cathode on the right, in accordance with some embodiments of the present disclosure;

FIG. 2 shows an illustrative diagram of the cell configuration of a lithium metal oxide cathode on the left, a lithium metal phosphate cathode in the middle and a blended cathode of the lithium metal oxide cathode and a lithium metal phosphate cathode on the right, in accordance with some embodiments of the present disclosure;

FIG. 3 shows an illustrative diagram of a blended electrode with a graphene sheet surface coating, in accordance with some embodiments of the present disclosure;

FIG. 4 shows an illustrative diagram of a blended electrode with a graphene sheet surface coating with the graphene sheet includes a number of defects formed by vacancies next to adjacent carbon atoms, in accordance with some embodiments of the present disclosure;

FIG. 5 shows an illustrative diagram from a side view of a blended electrode with graphene sheet surface coating, where the graphene sheet includes a number of defects formed by vacancies next to adjacent carbon atoms, in accordance with some embodiments of the present disclosure;

FIG. 6 shows an illustrative diagram of a blended electrode covered with graphene sheet flakes, in accordance with some embodiments of the present disclosure;

FIG. 7 shows illustrative diagrams of various types of graphene sheets and lithium ions in green-colored circles, in accordance with some embodiments of the present disclosure;

FIG. 8 shows an illustrative chart of a voltage vs. capacity curve of a) lithium metal oxide cathode material, b) lithium iron phosphate cathode material and c) blended lithium iron phosphate and lithium metal oxide cathode materials, in accordance with some embodiments of the present disclosure;

FIG. 9 shows an illustrative chart of a voltage vs. capacity curve of a) lithium metal oxide cathode material, b) lithium iron phosphate cathode material and c) blended lithium iron phosphate and lithium metal oxide cathode materials, in accordance with some embodiments of the present disclosure;

FIG. 10 shows an illustrative chart of capacity vs. cycle number of a) lithium metal oxide cathode material, b) lithium iron phosphate cathode material and c) blended lithium iron phosphate and lithium metal oxide cathode materials, in accordance with some embodiments of the present disclosure;

FIGS. 11-13 show illustrative charts of X-ray diffraction (XRD) pattern for a) a lithium metal oxide cathode material, b) a lithium iron phosphate cathode material, and c) graphite, in accordance with some embodiments of the present disclosure;

FIG. 14 shows a chart of a Raman spectroscopy analysis of graphene that can be used to quantify the number and orientation of graphene layers, in accordance with some embodiments of the present disclosure;

FIG. 15 shows an illustrative diagram of a lithium-ion battery with a blended cathode, in accordance with some embodiments of the present disclosure; and

FIG. 16 shows a flowchart of an illustrative process to generate the blended lithium-ion electrode, in accordance with some embodiments of the present disclosure.

### DETAILED DESCRIPTION

This disclosure provides, inter alia, novel blended electrode materials comprising a first mixture of a lithium metal oxide comprised of LiXO₂, wherein X is selected from the group comprising of nickel, cobalt, manganese, aluminum, iron, or mixtures thereof and a second mixture of a lithium iron phosphate comprised of LiYPO₄, wherein Y is selected from the group comprising of iron, manganese, cobalt, nickel, aluminum, titanate, or mixtures thereof for use in Lithium-ion (Li-ion) batteries. The blended Li-ion electrode materials of this disclosure improve the energy density, reduce the cost of the batteries and prolong energy capacity over a larger number of cell cycles of the batteries from continuous charging and discharging, thereby improving the performance of Li-ion batteries, relative to Li-ion batteries that employ one of lithium metal oxide or lithium iron phosphate cathodes. The blended Li-ion electrode of this disclosure comprises one or more LiNiO₂, LiCoO₂, LiMnO₂, LiAlO₂, and LiFeO₂, and one or more LiFePO₄, LiMnPO₄, LiCoPO₄, LiNiPO₄, LiAlPO₄, and LiTiPO₄.

In some embodiments, the blended Li-ion electrode of this disclosure comprises two or more metals, for example, the lithium metal oxide comprised of LiXZO₄, wherein X is selected from the group comprising of nickel, cobalt, manganese, aluminum, iron, and Z is selected from the group consisting of nickel, cobalt, manganese, aluminum, or iron. In some embodiments, the lithium metal oxide in the blended lithium-ion electrode includes three or more metals, (e.g., Li(NiₐCo_{b}Mn_{c})O₂, Li(NiₐAl_{b}Fe_{c})O₂, Li(CoₐMn_{b}Al_{c})O₂, Li(NiₐCo_{b}Al_{c})O₂, Li(CoₐFe_{b}Ni_{c})O₂, etc.). For example, the blended Li-ion electrode of this disclosure comprises of Li(M^{I}ₐM^{II}_{b}M^{III}_{c} . . . M^{N}ₙ)O₂, where M^{I}, M^{II}, M^{III}, . . . , M^{N}=Ni, Co, Mn, Al, Fe, etc. and a+b+c+. . . +n=1 including but not limited to Li(NiₐCo_{b}Mn_{c})O₂, Li(NiₐCo_{b}Al_{c})O₂, or Li(NiₐCo_{b}Mn_{c}Al_{d})O₂, and Li(M^{I′}ₐM^{II′}_{b}M^{III′}_{c} . . . M^{N′}ₙ)PO₄, where M^{I′}, M^{II′}, M^{III′}, . . . , M^{N′}=Fe, Mn, Co, Al, Ti, Sn, etc. and a+b+c++n=1, including but not limited to Li(FeₐMn_{b})PO₄, Li(FeₐCo_{b})PO₄, Li(FeₐNi_{b})PO₄, Li(FeₐAl_{b})PO₄, Li(FeₐTi_{b})PO₄, Li(MnₐCo_{b})PO₄, Li(MnₐNi_{b})PO₄, Li(MnₐAl_{b})PO₄, Li(MnₐTi_{b})PO₄, Li(CoₐNi_{b})PO₄, Li(CoₐAl_{b})PO₄, Li(CoₐTi_{b})PO₄, Li(NiₐAl_{b})PO₄, Li(NiₐTi_{b})PO₄, and Li(AlₐTi_{b})PO₄. In some embodiments, the lithium metal phosphate in the blended lithium-ion electrode includes three metals, (e.g., Li(FeₐCo_{b}Mn_{c})PO₄, Li(FeₐMn_{b}Al_{c})PO₄, or Li(FeₐMn_{b}Ti_{c})PO₄, etc.).

“Anode” refers to an electrode in a Li-ion battery where oxidation occurs during discharge of the electrochemical cell. An anode is identified in a battery as the negative electrode, where electrons are emitted during discharge for use by a load. An anode oxidizes material and releases positive ions to an electrolyte during discharge.

“Cathode” refers to an electrode in a Li-ion battery where reduction occurs during the discharge of the battery. A cathode is identified as the positive electrode, where electrons are received during discharge after use by a load. A cathode reduces positive ions received from an electrolyte during discharge. “Cathode material” refers to the overall group of substances that make up the cathode, such as cathode active material as well as other material, which may be inactive. In some embodiments, the cathode material includes at least one of lithium metal oxide and lithium iron phosphate. In some embodiments, the cathode material includes at least one of lithium metal oxide, lithium iron phosphate, or graphene sheets.

“Active material” refers to a component of an electrode that takes part in an electrochemical reaction during charging or discharging of an electrochemical cell including the electrode. For example, an electrode may include an active material, a binder, and a conductive additive, the active material corresponds to the component of the electrode that undergoes oxidation or reduction in an electrochemical reaction during charging or discharging. For example, anode active materials may include elemental materials, such as lithium, alloys including Si and Sn, or other lithium compounds, and intercalation host materials, such as graphite. For example, cathode active materials include, but are not limited to, those comprising lithium, lithiated compounds, non-lithiated compounds, and lithium metal phosphates such as LiFePO₄, LiMnPO₄, LiCoPO₄, LiNiPO₄, LiAlPO₄, LiTiPO₄, Li(FeₐMn_{b})PO₄, Li(FeₐCo_{b})PO₄, Li(FeₐNi_{b})PO₄, Li(FeₐAl_{b})PO₄, Li(FeₐTi_{b})PO₄, Li(MnₐCo_{b})PO₄, Li(MnₐNi_{b})PO₄, Li(MnₐAl_{b})PO₄, Li(MnₐTi_{b})PO₄, Li(CoₐNi_{b})PO₄, Li(CoₐAl_{b})PO₄, Li(CoₐTi_{b})PO₄, Li(NiₐAl_{b})PO₄, Li(NiₐTi_{b})PO₄, Li(AlₐTi_{b})PO₄, Li(NiₐCo_{b}Mn_{c})O₂, Li(NiₐCo_{b}Al_{c})O₂, Li(NiₐAl_{b}Fe_{c})O₂, Li(CoₐMn_{b}Al_{c})O₂, Li(NiₐCo_{b}Al_{c})O₂, Li(CoₐFe_{b}Ni_{c})O₂, and Li(CoₐMn_{b}Ni_{c}Al_{d})O₂, where a+b, a+b+c, or a+b+c+d=1.

“Electrolyte” refers to an ionically conductive material such as solvents, ionic liquids, metal salts, ions such as metal ions or inorganic ions, polymers, ceramics, and other components. An electrolyte may be an organic or inorganic solid or a liquid, such as a solvent (e.g., a non-aqueous solvent) containing dissolved salts. Non-aqueous electrolytes can include organic solvents, such as, cyclic carbonates, linear carbonates, fluorinated carbonates, benzonitrile, acetonitrile, tetrahydrofuran, 2-methyltetrahydrofuran, γ-butyrolactone, dioxolane, 4 methyldioxolane, N,N-dimethylformamide, N,N-dimethylacetamide, N,N-dimethylsulfoxide, dioxane, 1,2-dimethoxyethane, sulfolane, dichloroethane, chlorobenzene, nitrobenzene, diethyleneglycol, dimethylether, or mixtures thereof. Some examples of salts that may be included in electrolytes include lithium salts, such as LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂)(CyF_{2y-1}SO₂), (where x and y are natural numbers), LiF, LiCl, LiI, or mixtures thereof. For example, a liquid electrolyte characterized by a LiPF₆ salt dissolved in a carbonate solution may be used. In another example, a solid-state electrolyte, including but not limited to oxide, sulfide, or phosphates-based crystalline structures, may replace the liquid electrolyte.

“Graphene” refers to an allotrope of carbon in the form of a single layer of atoms in a two-dimensional hexagonal lattice in which one atom forms each vertex. It is the basic structural element of other allotropes, including graphite, charcoal, carbon nanotubes and fullerenes. The graphene used may be in the form of flakes, sheets, powders, and/or combinations thereof. Graphene sheets provide a structure that is about 100 times stronger than the strongest steel in proportion to its thickness. Graphene sheets, because of their unique two dimensions flat structure, have a density lower than any other steel, with a surface, such as surface-related, mass of 0.763 mg per square meter. Graphene in any form conducts heat and electricity very efficiently and is nearly transparent. In some embodiments, graphene sheets are blended into the electrode providing a formative material to construct ornate scaffolds usable in Li-ion battery electrodes to enhance ion transport and electric current conduction to yield specific capacity and power delivery figures not otherwise attainable by conventional battery technologies.

“Separator” refers to an ion conductive barrier used to separate an anode and a cathode in a Li-ion battery. A separator is a porous or semi-permeable membrane that restricts the passage of certain materials across the membrane, while allowing other materials, such as ions, to pass through the membrane. A separator provides a physical spacing between the anode and the cathode. A separator is not electrically conductive and provides a gap in electrical conductivity between the anode and the cathode in a Li-ion battery.

“Coating” may refer to a process of depositing or otherwise providing a layer (or partial layer) of one material over an underlying material. A “coating” or “coating material” may also refer to the layer (or partial layer) of material that is provided over the underlying material. A coating may provide a protective barrier to the underlying material, which may allow, for example, a degree of protection of the underlying material from reacting with other substances above the coating. Coatings may be formed by precipitating material onto a surface of an object in solution, such as a cathode, cathode active material, or suspended particles of a cathode active material. For example, coatings on suspended particles of a cathode active material may be formed by a cation-anion precipitation reaction in a suspension. Coatings may also be formed by depositing material onto a surface of an object, such as by atomic layer deposition or chemical vapor deposition processes. The protective coating materials are designed, for example, to protect the cathode active material from degradation by, e.g., HF, PF₅⁻, LiF, and LiOH. For example, the coating materials act to scavenge HF, PF₅⁻ and to be unreactive or inert in the presence of LiF and LiOH. The protective coating materials are also stable against LiFePO₄, or any other material used in cathodes.

A “protective barrier” refers to the property of a material, such as a coating, that isolates, prevents, or otherwise reduces the rate at which an undesired reaction or undesired contact takes place with a material underlying the coating. For example, a coating may serve as a protective barrier for an underlying material by preventing the underlying material from making direct contact with materials or substances above the coating, such as a liquid or solution. In another example, a metal phosphate coating of this disclosure or other coating reduces the rate at which a chemical or electrochemical reaction occurs between an underlying material and materials or substances above the coating and/or may prevent the chemical or electrochemical reaction from occurring at all. In another example, a metal phosphate coating of this disclosure or other coating over a cathode active material provides a protective barrier against oxidative degradation of an electrolyte that contacts the coating and/or the cathode active material.

A “cell cycle” refers to the number of charge and discharge cycles that a battery can complete. The cycle life of Li-ion batteries is affected by the depth of charge/discharge which is the amount of a battery's storage capacity that is extracted/utilized.

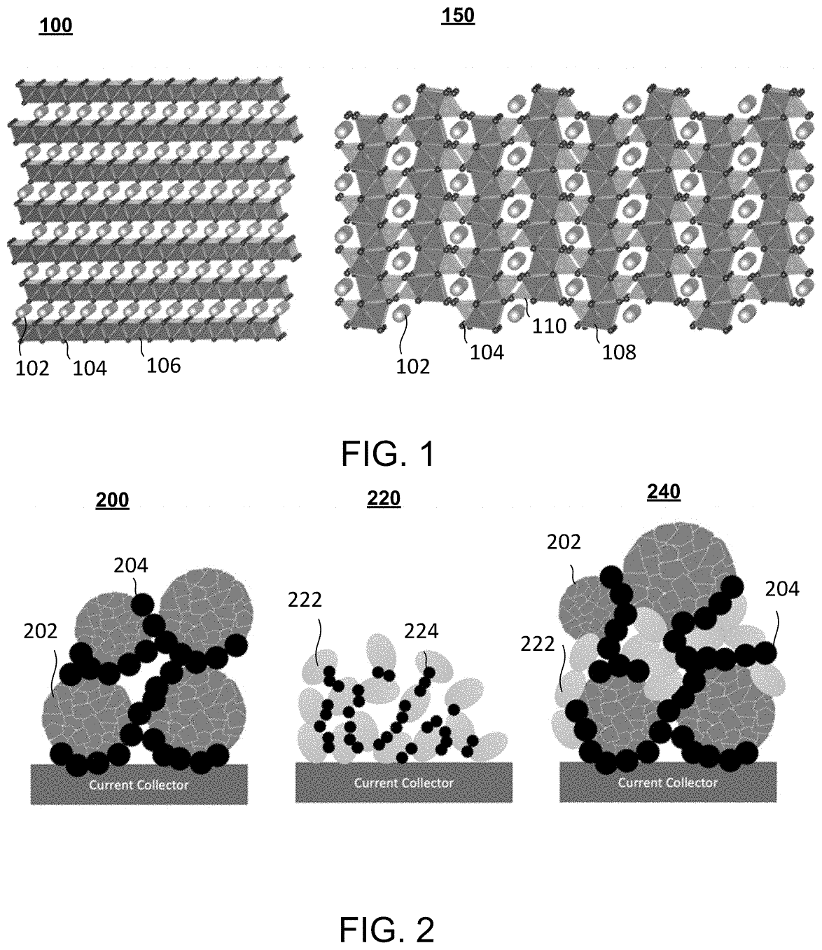

FIG. 1 shows a schematic diagram of the cell configuration of a lithium metal oxide cathode 100 on the left and a lithium metal phosphate cathode 150 on the right, in accordance with some embodiments of the present disclosure. In the lithium metal oxide cathode 100 the larger molecules 102 represent lithium (Li) atoms and smaller molecules 104 represent oxygen O atoms. The lithium metal oxide cathode 100 further includes a shaded polyhedron 106 where the shaded polyhedron 106 represents XO₆, where X is selected from the group consisting of nickel (Ni), cobalt (Co), Manganese (Mn), or Aluminum (Al) octahedron in lithium metal oxide (e.g., LiMO₂) cathode. Further, in lithium metal oxide (LiMO₂), the lithium-ion diffusions may occur in a two-dimension (2D) manner: i.e., XY plane. For example, the lithium-ion diffusions may occur on the surface of the lithium metal oxide (e.g., LiMO₂) cathode. The lithium iron phosphate cathode 150 includes a MO₆ octahedron 108, a polyhedron 110 represents PO₄, larger molecules 102 represent lithium (Li) atoms and smaller molecules 104 represent oxygen O atoms in lithium metal phosphate cathode 150. In the lithium metal phosphate, the Lithium-ion enters and exit in (010) lattice plane: (i.e., one dimensional (1D) lithium-ion channel).

FIG. 2 shows an illustrative diagram of the cell configuration of a lithium metal oxide cathode on the left, a lithium metal phosphate cathode in the middle, and a blended cathode of the lithium metal oxide cathode and the lithium iron phosphate cathode on the right, in accordance with some embodiments of the present disclosure. The left illustrative example of a cathode 200 includes large spheres 202 representing the lithium metal oxide cathode 200, and secondary uniform spherical particles 204 with an average size of ˜10 micrometers (μm). The uniform spherical particles 204 represent conducting agent, (e.g., carbon black). In the illustrative example, a binder is not shown but is present. The middle illustrative example of the cathode 220 is a lithium metal phosphate cathode and includes small oval shapes 222, smaller spherical particles 224, and a variety of different size particles. The small oval shapes represent primary particles and their aggregates. In the lithium iron metal cathode, the size of the primary particle can vary from 50 to 300 nm. In another embodiment, the lithium iron metal cathode, the size of the aggregates (including the primary particles) can vary from 200 nm to 3 μm. The lithium metal phosphate particles have a higher surface area as shown by the small oval shapes 222 being smaller in size when compared to large spheres 202 representing the lithium metal oxide cathode 200. In one embodiment, lithium metal oxide cathode may be single crystal, where the size of particles may be in a range from 1 to 9 μm. Lithium metal oxide cathode may be smaller polycrystalline, where the size of particles may be in a range from 2 to 8 μm. Lithium metal oxide cathode may be a blend of single crystal and polycrystal, or two different single crystal sizes, or two different polycrystalline sizes. In another embodiment, the lithium metal oxide cathode may have narrower or broader particle spectrum sizes, where D10, D50, and D90 values may differ significantly from 1 to 25 μm. The smaller spherical particles 224 may be selected from one or more Super P, Ketjen black, acetylene black, etc. In some embodiments, the smaller spherical particles 224 may be used as a sole conductive agent or as a mixture to other types of carbon blacks, carbon nanotube, conductive polymer, and/or graphene. The right illustrative example of the cathode 240 in FIG. 2 is an example of when lithium metal phosphate, and lithium metal oxide are blended. The blended electrode may increase higher loading level (mg/cm²) and tab/pellet/packing density (g/cm³). As shown in FIG. 2, the right illustrative example of the cathode 240 includes void space of lithium metal oxide cathode 202 filled with smaller lithium iron phosphate cathode 222 materials. In some embodiments, the loading level for pure lithium iron phosphate and lithium metal oxide cathodes may vary from 7 to 18 mg/cm′ and 15 to 35 mg/cm′. In some embodiments, the blended cathode may improve the loading level to a range of 16 to 40 mg/cm′. In some embodiments, the ratio between lithium iron phosphate and lithium metal oxide materials will dictate the loading level and their size. For example, the higher the ratio of the lithium metal oxide to lithium iron phosphate, the higher the loading level. In some embodiments the ratio of lithium metal oxide to lithium iron phosphate is selected from 90:10, 91:9, 92:8, 93:7, 94:6, 95:5, 96:4, 97:3, 98:2, and 99:1. In some embodiments, the pressed density of a blended electrode with lithium metal oxide and lithium iron phosphate will vary from 2.3 to 2.7 g/cm³, and 2.5 to 4.0 g/cm³. The pressed density of blended cathode of lithium metal oxide and lithium metal phosphate may improve when compared to using lithium iron phosphate cathode materials.

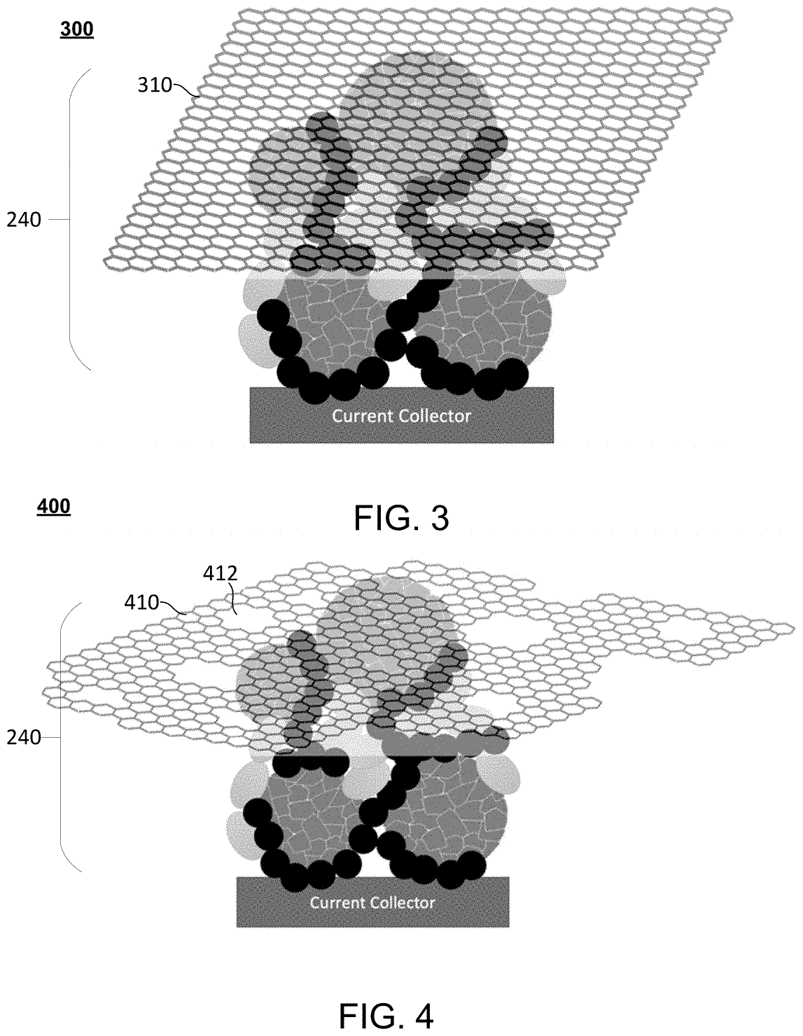

FIG. 3 shows an illustrative diagram of a blended electrode with a graphene sheet surface coating, in accordance with some embodiments of the present disclosure. FIG. 3 shows a blended electrode 240 (e.g., a cathode) having lithium metal oxide and lithium metal phosphate and a graphene sheet 310 covering the top of the blended electrode. The graphene sheet 310 is an allotrope of carbon in the form of a single layer of atoms in a two-dimensional hexagonal lattice in which one atom forms each vertex. In some embodiments, the number of graphene sheets 310 can vary between one and several hundred, giving rise to a c-directional dimension, (e.g., thickness L of typically 0.34 nm to 100 nm). In some embodiments, the length or width (L,) of the graphene sheet may be in a range of tens of nanometers to microns. In some embodiments, a sheet of graphene may be transferred on the cathode film using wet chemistry. For example, a layer of PMMA is spin-coated on to graphene to act as support, then remove PMMA using a solvent. In another embodiment, graphene may be grown or deposited using chemical deposition (CVD) technique. Graphene may be transferred using chemical blended method, followed by thermal decomposition using cellulose-type of precursors.

FIG. 4 shows an illustrative diagram of a blended electrode with a graphene sheet surface coating with the graphene sheet includes a number of defects formed by vacancies next to adjacent carbon atoms, in accordance with some embodiments of the present disclosure. FIG. 4 shows a blended electrode 240 (e.g., a cathode) having lithium metal oxide and lithium iron phosphate and a graphene sheet 410 covering the top of the blended electrode with vacancies or holes 412. In some embodiments, the vacancy 412 types may include mono-, di-, tri-, and quad-vacancy. In some embodiments, the graphene sheet may include other types of defects, for example, holes. The holes 412 may be present naturally or synthetically created by heat treatment, chemical process, and/or ion bombardment. In some embodiments, the graphene sheet wraps around the blended electrode materials, which may cause mechanical strain naturally and result in defects to the graphene sheet.

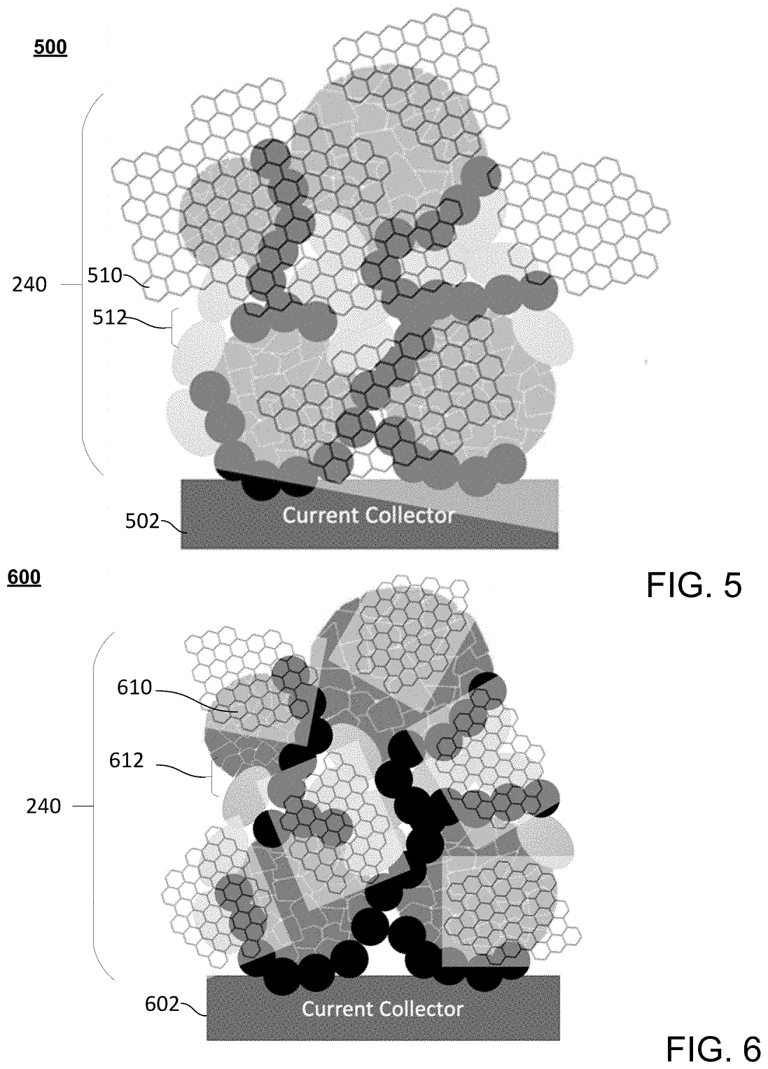

FIG. 5 shows an illustrative diagram from a side view of a blended electrode with graphene sheet surface coating, where the graphene sheet includes a number of defects formed by vacancies next to adjacent carbon atoms, in accordance with some embodiments of the present disclosure. FIG. 5 shows a blended electrode 240 (e.g., a cathode) having lithium metal oxide and lithium iron phosphate and a graphene sheet 510 covering the side of the blended electrode with vacancies 512. In some embodiments, the graphene sheet will be dispersed throughout the blended electrode including around the edges or sides. In some embodiments, the graphene sheet 510 may act as a coating. The graphene sheet 510 will be in three dimensions, depending on electrode morphology and roughness and will cover the top, sides, and throughout the blended electrode 240.

FIG. 6 shows an illustrative diagram of a blended electrode covered with graphene sheet flakes, in accordance with some embodiments of the present disclosure. FIG. 6 shows a blended electrode 240 (e.g., a cathode) having lithium metal oxide and lithium iron phosphate and a graphene sheet flakes 610 covering the side of the blended electrode with vacancies 612. In some embodiments, the graphene used here may be in the form of flakes, sheets, powders, and/or combinations thereof. In some embodiments, the flake may be composed of 1 to 15 graphene layers. In some embodiments, the lateral size may vary from 0.1 to 20 μm for the graphene flakes.

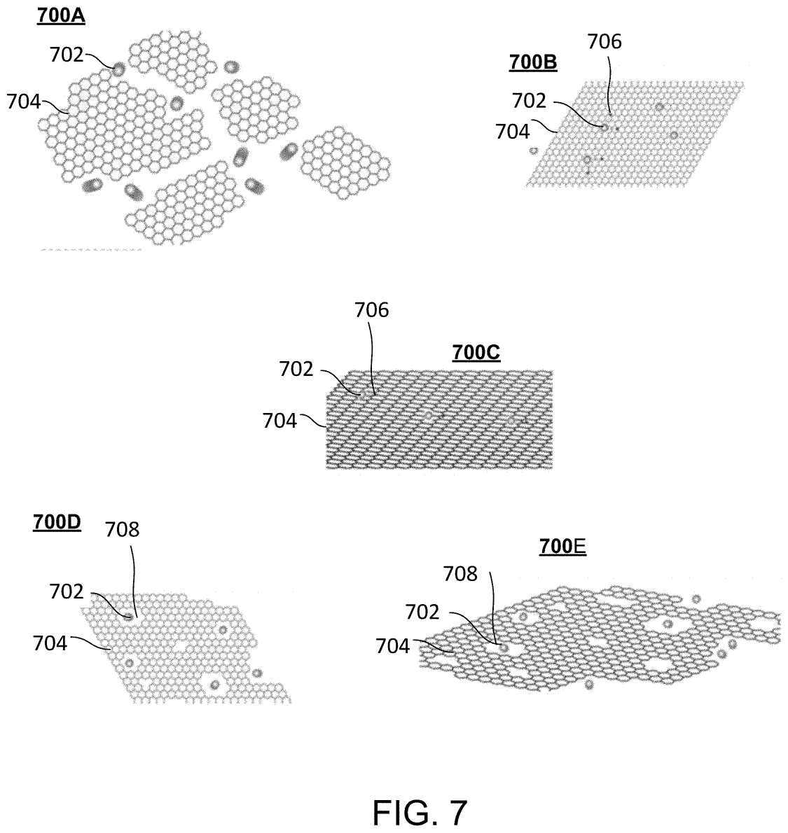

FIG. 7 shows illustrative diagrams of various types of graphene sheets, in accordance with some embodiments of the present disclosure. FIG. 7 shows various graphene sheets, including a graphene flakes 700A, pristine graphene 700B without defects from a top view and pristine graphene 700C without defects from a side view, graphene sheets with defects 700D from a top view and graphene sheets with defects 700E from a side view. In some embodiments, in a pristine graphene sheet 700B and 700C, the lithium-ion will move laterally along the sheet. To achieve the desired result and to permit lithium ions to travel between the cathode and anode, the graphene sheets may include defects/holes or empty space between the graphene sheets. In some embodiments, to further improve the performance of the graphene sheets in the blended electrode, the graphene sheets may include the addition of graphene functional groups, (e.g., hydroxide (—OH), epoxy (—O), carbonyl (═O), or carboxylic (—COOH) groups). In some embodiments, the functional groups may enhance Li transport or slow down or suppress transition metal dissolutions. In some embodiments, graphene sheets may be doped with n-type (e.g., nitrogen) or p-type dopant (e.g., boron). By employing the graphene sheet, the performance of the blended electrode is improved.

In some embodiments, the graphene sheets may be functionalized. For example, the graphene sheet may be dispersed onto the blended electrode. In some embodiments, chemical functionalization of graphene sheets enables the material to be processed by solvent assisted techniques, such as layer-by-layer assembly, spin-coating, and filtration, and also prevents the agglomeration of single-layer graphene (SLG) during reduction and maintains the inherent properties of graphene. In some embodiments, the functionalization of graphene sheets may be performed by covalent and noncovalent modification techniques. In both instances, surface modification of graphene oxide followed by reduction has been carried out to obtain functionalized graphene.

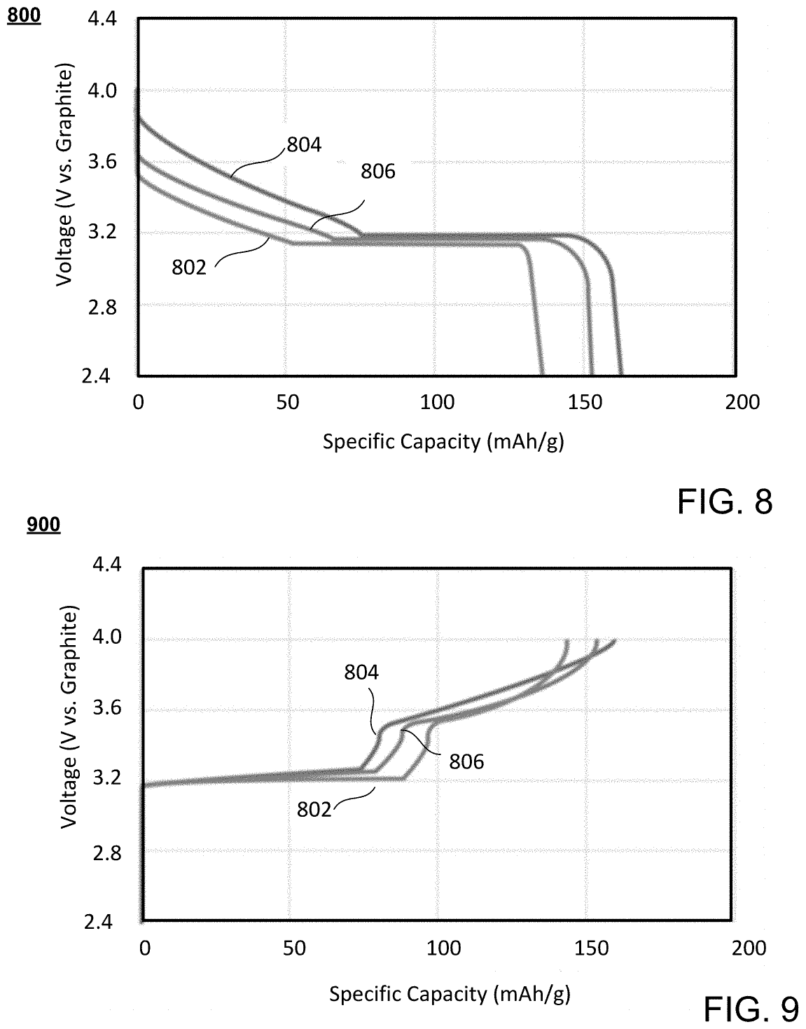

FIG. 8 shows an illustrative chart of a voltage vs. capacity curve for a variety of blended lithium iron phosphate and lithium metal oxide cathode materials during discharging, in accordance with some embodiments of the present disclosure. As shown in FIG. 8, a number of different blend ratios are illustrated. For example, line 802 includes a lower lithium metal oxide ratio than line 806, which also includes a lower lithium metal oxide ratio than line 804. For example, line 804 includes a higher ratio of lithium metal oxide and therefore has higher average voltage values and reaches a specific capacity of 160 (mAh/g). Line 802 includes a lower ratio of lithium metal oxide, therefore, has an average lower voltage than 804 and 806. As the batteries discharge and the energy leaves, the lithium-ion moves back to lithium metal oxide (e.g., NMC) cathode from the anode, at the upper voltage region (above 3.2 V). The plateau near 3.2 V vs. graphite indicates two phase transitions between FePO₄ and LiFePO₄. Depending on the ratio between lithium iron phosphate and lithium metal oxide, capacity and voltage will vary.

FIG. 9 shows an illustrative chart of a voltage vs. capacity curve for a variety of blended lithium iron phosphate and lithium metal oxide cathode materials during charging, in accordance with some embodiments of the present disclosure. As shown in FIG. 9, a number of different blend ratios are illustrated. For example, line 802, line 806, and line 804 are illustrated with varying blend ratios. For example, line 802, with a higher ratio of lithium metal oxide, leads to a higher capacity. In another example, the plateau at 3.2 V indicates two phase transitions between LiFePO₄ and FePO₄. As shown in FIG. 9, lithium-ion moves to graphite from the lithium metal oxide (e.g., NMC) cathode at the upper voltage region above 3.2 V vs. graphite. Depending on the ratio between lithium iron phosphate (e.g., LFP) and lithium metal oxide (e.g., NMC), capacity and charging voltage will vary.

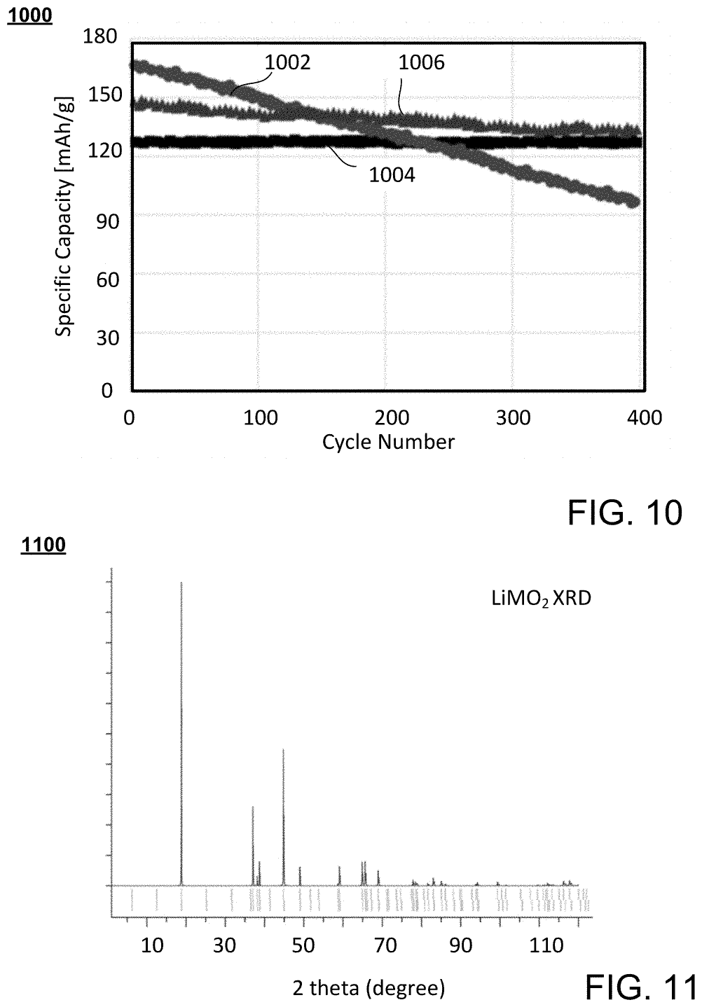

FIG. 10 shows an illustrative chart of capacity vs. cycle number of a) lithium metal oxide cathode 1002 material, b) lithium iron phosphate cathode 1004 material, and c) blended lithium iron phosphate and lithium metal oxide cathode 1006 materials, in accordance with some embodiments of the present disclosure. As shown in FIG. 10, the specific capacity of a lithium metal oxide illustrated by line 1002 starts higher specific capacity and over many cell cycles drops, while the specific capacity of a lithium iron phosphate illustrated by line 1004 starts lower but maintains the specific capacity over many cell cycles (i.e. stable cycling), and the specific capacity of the blended electrode of a lithium metal oxide and lithium iron phosphate illustrated by line 1006 starts with a capacity between the two pure cathodes and decreases slightly over many cell cycles. When considering high charging C rates, for example, above 2C (i.e., 30 minutes), 3C (20 minutes), 6C (10 minutes), lithium iron phosphate typically leads to overpotential (meaning, it needs extra energy/voltage to charge the cell). Graphene can help increase the electronic conductivity in the blended cell, therefore, charging overpotential will be decreased (when compared with pure lithium iron phosphate (LFP) cathode or lithium metal oxides cathode).

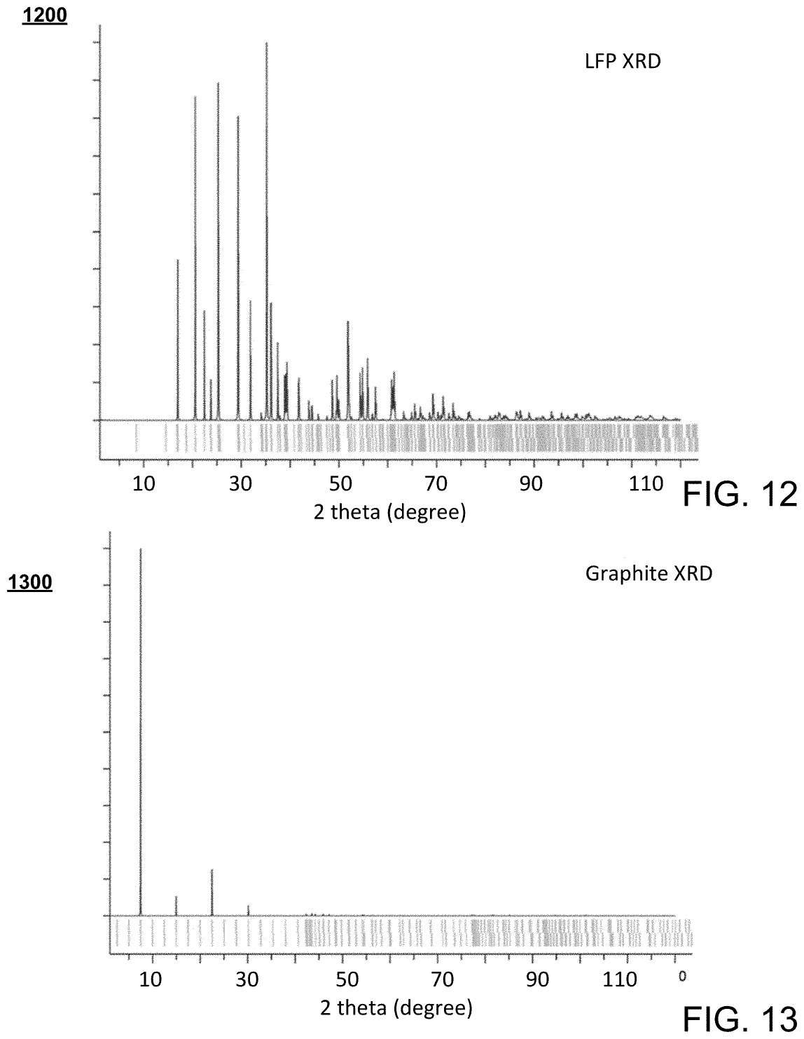

FIGS. 11-13 show illustrative charts of a X-ray diffraction (XRD) pattern for a) a lithium metal oxide cathode material, b) a lithium iron phosphate cathode material, and c) graphite, in accordance with some embodiments of the present disclosure. Based on the X-ray diffraction (XRD) pattern for each individual pattern, quantifying the concentration of the different mixtures may be performed, including graphite, lithium iron phosphate, and lithium metal oxide. Since graphene is very thin (few layers), its signature will not be as strong for the XRD measurements and can be quantified using Raman spectroscopy.

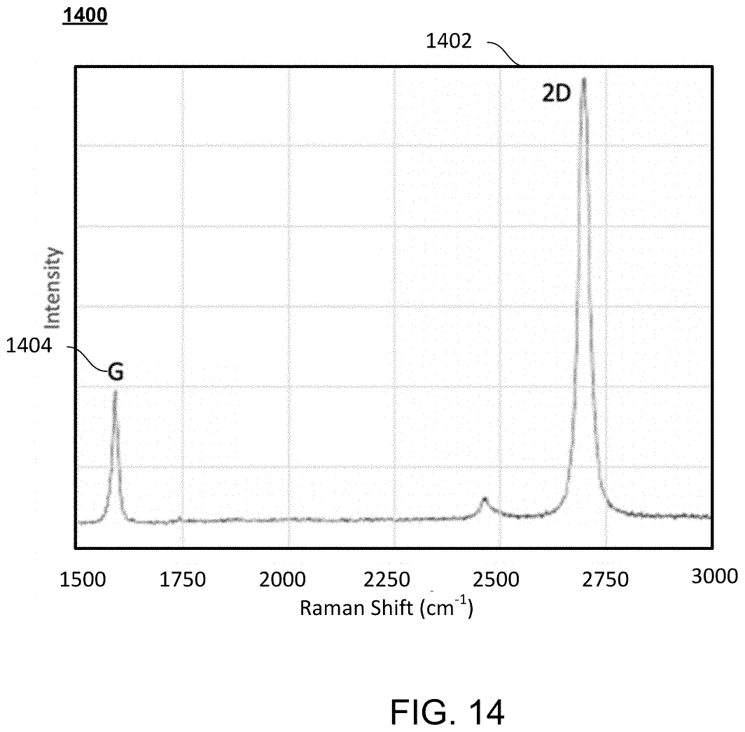

FIG. 14 shows a chart of a Raman spectroscopy analysis of graphene that can be used to quantify the number and orientation of graphene layers, in accordance with some embodiments of the present disclosure. As shown in FIG. 14, the Raman spectroscopy analysis illustrates two peaks, with a first peak 1404 around 1587 cm⁻¹ and a second peak 1402 around 2700 cm⁻¹. The first peak 1404 represents graphene and has a stronger signature for the G band than the graphite. The G band typically appears around 1587 cm¹, is in an in-plane vibration mode involving sp² hybridized carbon atoms. Since graphite is just stacked graphene, the Raman spectra of graphene and graphite, at first glance look very similar. The most obvious difference is the intensity of the peaks at the G band and the 2D band in graphene when compared to graphite. The second peak 1402 represents the 2D band for graphene and has a higher peak signature than graphite. The 2D band is used to determine the graphene layer thickness. The ratio of the second peak 1402 over the first peak 1404 (2D band/G band) is often used to measure the quality of graphene (i.e., defect-free).

FIGS. 11-14 provide a clear method to quantify the concentration of the blended electrode. For example, with the use of X-ray diffraction and Raman spectroscopy techniques, the composition of the blended electrode with lithium metal oxide, lithium iron phosphate and graphene can be confirmed. In one example, the cathode's property during manufacturing can be validated by confirming the concentration of the lithium metal oxide in the blended electrode, the concentration of the lithium iron phosphate in the blended electrode, and graphene in the blended electrode. At a larger manufacturing scale, cell resistivity may be used to compare the pristine vs. modified cell chemistry, where the resistivity of the graphene-modified cell is expected to be lower.

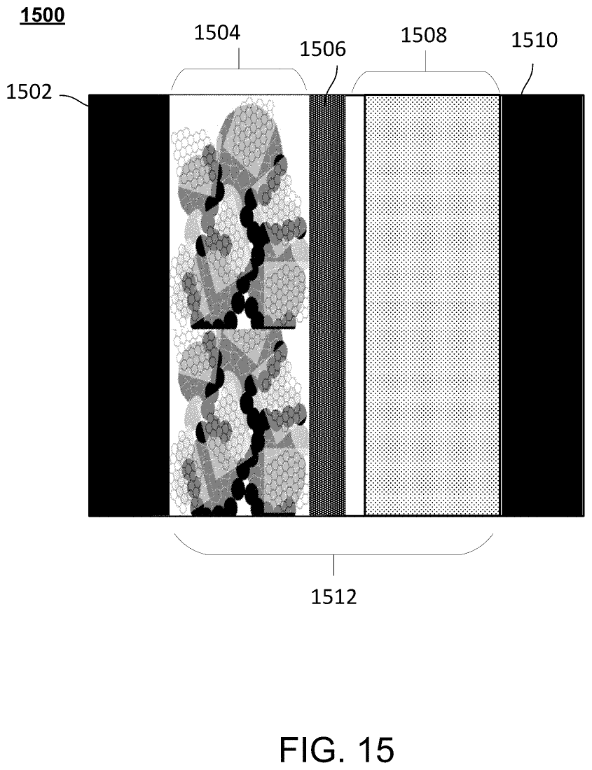

FIG. 15 shows an illustrative diagram of a lithium-ion battery 1500 with a blended cathode, in accordance with some embodiments of the present disclosure. Each lithium-ion battery 1500 may be part of a battery module or pack containing multiple Li-ion batteries in an electric vehicle. An electric vehicle may be a car (e.g., a coupe, a sedan, a truck, an SUV, a bus), a motorcycle, an aircraft (e.g., a drone), a watercraft (e.g., a boat), or any other type of vehicle. In some embodiments, vehicle may be configured to operate autonomously or semi-autonomously. The lithium-ion battery 1500 includes current collector 1502, a cathode 1504, separator 1506, anode 1508, a current collector 1510, and electrolyte 1512. The current collector 1502 may be made of aluminum (Al), or its alloy configured to permit current to flow to and from the cathode. The cathode 1504 may be configured as the positive electrode, where electrons are received during discharge after use by a load. Any one of the previously described blended electrodes may be cathode 1504. The separator 1506 may be configured as an ion conductive barrier used to separate an anode and a cathode in a lithium-ion battery, as previously described above. The anode 1508 may be configured as the negative electrode, where electrons are emitted during discharge for use by a load. The current collector 1510 may be a copper (Cu) or aluminum (Al) plate configured to permit current to flow to and from the anode. For graphite anode, Cu current collector may be used. For other oxide-type cathodes such as Li₄Ti₅O₁₂, Al current collector may replace the Cu-based current collector. The electrolyte 1512 may be an ionically conductive material configured to allow the movement of lithium ions between the anode 1508 and the cathode 1504.

The cell configuration in the Li-ion battery of this disclosure may be prismatic, cylindrical, or pouch type. A cylindrical cell typically consists of sheet-like anodes, separators, and cathodes that are sandwiched, rolled up, and packed into a cylinder-shaped can. Prismatic cells typically consist of large sheets of anodes, cathodes, and separators sandwiched, rolled up, and pressed to fit into a metallic or hard-plastic housing in cubic form. The electrodes can also be assembled by layer stacking rather than jelly rolling. Pouch cells, on the other hand, typically do not have a rigid enclosure and use a sealed flexible foil as the cell container. This reduces the weight and leads to flexible cells that can easily fit the available space of a given product. The electrode and separator layers of a pouch cell are typically stacked rather than jelly-rolled.

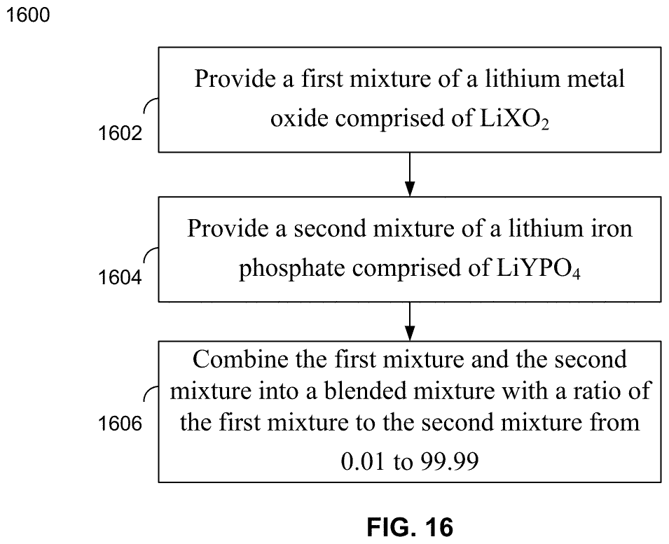

FIG. 16 shows a flowchart of an illustrative process 1600 to generate the blended lithium-ion electrode, in accordance with some embodiments of the present disclosure. Process 1600 may be executed at least in part in a batch or continuous process. A storage vessel may be used to store the raw materials.

At 1602, from storage, a first mixture is provided of a lithium metal oxide comprised of LiXO₂, where X is selected from the group consisting of nickel, cobalt, manganese, aluminum, iron, or mixtures thereof.

At 1604, from storage, a second mixture is provided of a lithium iron phosphate comprised of LiYPO₄, wherein Y is selected from the group consisting of iron, manganese, cobalt, nickel, aluminum, titanate, or mixtures thereof.

At 1606, in a vessel, the first mixture and the second mixture are combined into a blended mixture with a ratio of the first mixture to the second mixture from 0.1 to 99.9. In some embodiments, the blended electrodes of lithium metal oxide and lithium iron phosphate materials of this disclosure are synthesized via various solid-state methods. One method of performing solid-state synthesis is a ball-milling process. In some embodiments, the solid-state methods are followed by an optional spray dryer processing step to facilitate the drying and secondary particle formation.

The blended electrodes of lithium metal oxide and lithium iron phosphate materials of this disclosure are blended to make a cathode active materials. In some embodiments, graphene sheets are deposited into the mixture. Non-limiting examples of deposition techniques include chemical vapor deposition, physical vapor deposition, pulsed laser deposition, emulsion, sol-gel, atomic layer deposition, and/or other deposition techniques. In some embodiments, the first mixture of the lithium metal oxide has a higher energy density than the second first mixture of the lithium iron phosphate. Further, the second first mixture of the lithium iron phosphate has higher thermal properties than the first mixture of the lithium metal oxide. In some embodiments, the optimum amount of lithium metal oxide and lithium iron phosphate materials may be tuned such that the ratio between the first mixture of the lithium metal oxide comprised of LiXO₂ and the second mixture of the lithium iron phosphate comprised of LiYPO₄ is selected to balance the energy density and thermal properties.

In some embodiments, the optimum amount of graphene sheets on the blended electrode material surface may be tuned by the secondary heat-treatment conditions and in the presence of reducing gas agents such as N₂, Ar, H₂, or gas mixture thereof. For example, a coated cathode with graphene sheets can be made by forming a reaction mixture that includes the cathode active material, a cation precursor, and an anion precursor in a solvent and initiating a precipitation reaction between the cation precursor and the anion precursor to form the graphene sheet material on the blended cathode active material. The graphene sheet can be formed in the absence of the blended cathode active material and subsequently combined with the blended cathode active material to form a composite in which the graphene sheet are in contact with and at least partially surround particles of the blended cathode active material. This type of coating method is described in U.S. Patent Application Publication No. 2016/0190585. The coating methods can, optionally, include grinding the mixture of graphene sheet material and blended cathode active material and calcining the product, as described in U.S. Patent Application Publication No. 2014/0106223.

The graphene sheets can also be formed using sol-gel techniques such as those described in J. Cho et al., Electrochem. Solid-state Lett. 3, 362 (2000); and J. Cho et al., Chem. Mater 12, 3788 (2000).

Wet-chemical processes also can be used to form the blended cathode with graphene sheets dispersed therein. An illustrative example of a wet chemical process is described in S. Myung et al., Chem. Mater 17, 3695 (2005) for the formation of an Al₂O₃ coating on Li[Li_{0.05}Ni_{0.4}Co_{0.15}Mn_{0.4}]O₂ cathode active material particles. In this process, a cation precursor is dissolved in an organic solvent, such as ethanol, at or near room temperature and that solution is slowly added to a solution of the cathode active material. The mixture is then heated with stirring and the resulting coated cathode material is subsequently fired at a high temperature to produce coated particles of the active cathode material.

Other oxide coating techniques can also be employed. Electrostatic spray deposition (EDS), as illustrated in K. Y. Chung et al., J. Electrochem. Soc. 152, A791 (2005), 20 and mechanochemical process, as illustrated in S. Kim et al., J. Electroceram. 30, 159 (2013); and J.-K. Noh et al., Sci. Rep. 4, 4847 (2014). In an EDS process, cathode active materials are treated with metal-containing nitrate compounds, which serve as precursors to the cathode coating material. In a mechanochemical process (also known as a high-energy ball-milling process), a surface coating is applied on powders of a cathode active material, as illustrated in Kim et al. and J.-K. Noh et al. which describe Li₂MnO₃ cathode active materials coated with Cr-containing oxides; and LiNi_{0.5}Mn_{0.3}Co_{0.2}O₂ (NMC) cathode active material powders with the average size of ˜10 μm coated with a Li₂MnO₃ shell. Other suitable synthetic routes include: co-precipitation route, as described in Y-K. Sun et al., Nat. Mater 8, 320 (2009); and Y-K. Sun et al., Nat. Mater 11, 942 (2012); atomic layer deposition (ALD), as described in J. Lu et al., Nat. Commun. 5, 5693 (2014) and J. Park et al., Chem. Mater. 26, 3128 (2014); and thin film deposition, as described in G. Tan et al., Nat. Commun. 7, 11774 (2016).

### INCORPORATION BY REFERENCE

All documents cited herein, including patents, patent applications, papers, text books, and the like, and the references cited therein, to the extent that they are not already cited herein, are hereby incorporated by reference in their entirety. In the event that one or more of the incorporated documents and similar materials differ from or contradict this application, including but not limited to defined terms, term usage, described techniques, or the like, this application controls.

### Experimental Procedure

Lithium iron phosphate cathode materials will be mixed with lithium metal oxide cathode materials at room temperature using solid-state of solution-based approach with a mixing time varying from 5 min to 24 hours. The pH of the solution may be controlled by the presence of acid or base. Then, the mixture will be optionally annealed at elevated temperature may be any of the following values or in a range of any two of the following values: 50, 75, 100, 125, 150, 200, 400, and 600° C. The mixture is then aged. The aging time may be any of the following values or in a range of any two of the following values: 1, 2, 3, 4, 5, 10, 20, 30, 40, and 50 minutes; or, 1, 2, 3, 4, 8, 12, 16, or 24 hours. Reducing/oxidizing conditions may be controlled by the presence of different gas agents including but not limited to N₂, O₂, Air, Ar, H₂, CO, CO₂, a mixture thereof. The materials may include a thin coating layer at the outer surface in the form of an island or conformal coatings composed of carbon or binary oxides. Other types of coating materials includes but are not limited to AlPO₄, Ca₂P₂O₇, YPO₄, Sn₅(PO₅)₂, Sn₃(PO₄)₂, Hf₂P₂O₉, BiPO₄, Bi₃PO₇, Mn₂P₂O₇, Mn₃(PO₄)₂, Ni₃(PO₄)₂, Sn₂P₂O₇, LiAlO2, Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, LiScO₂, Li₂TiO₃, Li₂MnO₃, LiFeO₂, Li₂CoO₃, LiNi₂O₄, Li₂NiO₃, and Li₂ZrO₃. Graphene sheets may be transferred, deposited, or mixed with cathode materials. One non-limiting method is to mix and disperse graphene nanoflake (GNF) with ethyl cellulose and/or nitro-ethyl cellulose, followed by secondary mild heat treatment varying from 100 to 400° C. Other materials may be used to substitute/replace graphene: e.g., MWCNT, SWCNT, fullerene, borophene, graphyne, borophene, germanene, silicone, Si₂BN, stanine, phosphorene, molybdenite, as well as transition metal dichalcogenides such as MOS₂, WSe₂, HfS₂, MXenes where M=Ti, Mo, W, Nb, Zr, Hf, V, Cr, Ta, and Sc, X=C or N, Tx=O/OH/F.

Active materials containing blended cathode will be mixed with conductive agents such as carbon and binder materials in N-Methyl-2-pyrrolidone (NMP) solution to form a slurry. The slurry will be coated onto Al foil, then dried in the oven to remove NMP solvent. The loading level of cathode materials varies from 10 to 40 mg/cm² and the packing density can vary from 1.5 to 4.0 g/cc. The electrode will be assembled as the cathode in Li-ion batteries, where the anode materials can be Li metal, graphite, Si, SiOₓ, Si nanowire, lithiated Si, or mixture thereof. A traditional liquid electrolyte with LiPF₆ salt, dissolved in carbonate solutions, may be used. In some embodiments, a solid-state electrolyte including but not limited to oxide, sulfide, or phosphates-based crystalline structure may replace the liquid electrolyte.

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A blended lithium-ion electrode comprising:
a first mixture of a lithium metal oxide comprised of LiXO₂, wherein X is selected from a group comprising of nickel, cobalt, manganese, aluminum, iron, or mixtures thereof; and
a second mixture of a lithium iron phosphate comprised of LiYPO₄, wherein Y is selected from a group comprising of iron, manganese, cobalt, nickel, aluminum, titanate, or mixtures thereof,
wherein the first mixture and the second mixture are combined in a blended mixture with a ratio of the first mixture to the second mixture from 0.01 to 99.99.

2. The blended lithium-ion electrode of claim 1, wherein the blended lithium-ion electrode is a cathode.

3. The blended lithium-ion electrode of claim 1, further comprising:
a graphene additive at a concentration of 0.01 to 30 wt % combined in the blended lithium-ion electrode of the first mixture and the second mixture.

4. The blended lithium-ion electrode of claim 1, wherein:
the blended lithium-ion electrode is part of an electrochemical cell,
the first mixture of the lithium metal oxide has a higher energy density than the second first mixture of the lithium iron phosphate,
the second first mixture of the lithium iron phosphate has higher thermal conductivity than the first mixture of the lithium metal oxide, and
the ratio between the first mixture of the lithium metal oxide comprised of LiXO₂ and the second mixture of the lithium iron phosphate comprised of LiYPO₄ is selected based on the higher energy density and the higher thermal conductivity.

5. The blended lithium-ion electrode of claim 1, wherein a concentration of the first mixture in the blended lithium-ion electrode is in a range of 1-10 weight %.

6. The blended lithium-ion electrode of claim 1, wherein the first mixture of the lithium metal oxide is comprised of LiXZO₄, wherein Z is selected from the group comprising of nickel, cobalt, manganese, aluminum, iron, or mixtures thereof.

7. The blended lithium-ion electrode of claim 1, further comprising a protective coating configured to be resistant against electrolyte degradation that can scavenge HF and PF₅⁻.

8. The blended lithium-ion electrode of claim 1, further comprising a protective coating comprised of LiF that is configured to facilitate cell cycling.

9. The blended lithium-ion electrode of claim 8, wherein the protective coating comprises LiOH configured against electrolyte decomposition.

10. The blended lithium-ion electrode of claim 1, wherein X is nickel, cobalt, manganese, aluminum, or mixture.

11. The blended lithium-ion electrode of claim 1, wherein the blended lithium-ion electrode is part of an electrochemical cell configured with a cell capacity in a range of 1 to 300 Ah.

12. The blended lithium-ion electrode of claim 1, wherein the blended lithium-ion electrode is part of an electrochemical cell configured with an average voltage range from 3.2 to 4.4 V.

13. The blended lithium-ion electrode of claim 1, wherein the blended lithium-ion electrode is part of an electrochemical cell configured with an average capacity in a range from 120 to 250 mAh/g when charged at a 0.1 C-rate.

14. The blended lithium-ion electrode of claim 1, wherein:
the blended lithium-ion electrode is part of a lithium-ion battery, and
the lithium-ion battery is configured for use in an electric vehicle.

15. The blended lithium-ion electrode of claim 1, wherein the first mixture and the second mixture enable charging at a 2 C-rate.

16. The blended lithium-ion electrode of claim 1, wherein the first mixture and the second mixture enable charging at a 3 C-rate.

17. The blended lithium-ion electrode of claim 1, wherein the first mixture and the second mixture enable charging at greater than a 3 C-rate.

18. A lithium-ion battery comprising:
a separator;
a blended lithium-ion electrode, wherein the separator is between the blended lithium-ion electrode and an anode, wherein the blended lithium-ion electrode comprises:
a first mixture of a lithium metal oxide comprised of LiXO₂, wherein X is selected from a group consisting of nickel, cobalt, manganese, aluminum, iron or mixture thereof; and
a second mixture of a lithium iron phosphate comprised of LiYPO₄, wherein Y is selected from a group consisting of iron, manganese, cobalt, nickel, aluminum, titanate, or mixtures thereof,
wherein the first mixture and the second mixture are combined in a blended mixture with a ratio of the first mixture to the second mixture from 0.01 to 99.99.

19. The lithium-ion battery of claim 18, further comprising:
an electrolyte disposed between the anode and the blended lithium-ion electrode.

20. A method of manufacturing a blended lithium-ion electrode, comprising:
providing a first mixture of a lithium metal oxide comprised of LiXO₂, wherein X is selected from a group consisting of nickel, cobalt, manganese, aluminum, iron, or mixtures thereof;
providing a second mixture of a lithium iron phosphate comprised of LiYPO₄, wherein Y is selected from a group consisting of iron, manganese, cobalt, nickel, aluminum, titanate, or mixtures thereof; and
combining the first mixture and the second mixture into a blended mixture with a ratio of the first mixture to the second mixture from 0.01 to 99.99.
